(19) United States
(12) Patent Application Publication
(10) Pub. No.: US 2017/0037892 A1
(43) Pub. Date: Feb. 9, 2017

(54) ANTI-SPLITTING DEVICE

(71) Applicant: U-C Coatings, LLC, Buffalo, NY (US)

(72) Inventor: James A. Higgins, Saint Marys, PA (US)

(21) Appl. No.: 15/226,172

(22) Filed: Aug. 2, 2016

Related U.S. Application Data
(60) Provisional application No. 62/200,874, filed on Aug. 4, 2015.

(51) Int. Cl. F16B 15/00; B21G 3/00

(52) U.S. Cl. CPC F16B 15/0046; B21G 3/005; F16B 2015/0076

(57) ABSTRACT

An anti-splitting device including a base portion, a plurality of protrusions and first, second, third and fourth extensions. The base portion has a first surface and a second surface oppositely disposed relative to the first surface, a first edge and a second edge oppositely disposed relative to the first edge, and a third edge and a fourth edge oppositely disposed relative to the third edge. The plurality of protrusions are positioned about and extending from the first surface. The first extension is positioned at an intersection of the first and third edges, the second extension is positioned at an intersection of the third and second edges, the third extension is positioned at an intersection of the second and fourth edges and the fourth extension is positioned at an intersection of the fourth and first edges. Each of the first, second, third and fourth extensions extend from the second surface.

### CROSS-REFERENCE TO RELATED APPLICATIONS

This patent application claims the benefit under 35 U.S.C. §119(e) of U.S. Provisional Patent Application No. 62/200,874, filed Aug. 4, 2015, which application is incorporated herein by reference.

### TECHNICAL FIELD

The present disclosure relates generally to anti-splitting devices, more particularly to an anti-splitting device which is inserted into an end of a log, and even more particularly to an anti-splitting device which is inserted into an end of a log which may be readily removed from the log.

### BACKGROUND OF THE INVENTION

Fallen timber and procured wood are materials central to the logging industry. Freshly cut wood naturally contains water, in both liquid and vapor forms, which makes the wood more saturated than the surrounding environment. The nature of wood is such that, with the cyclical change of humidity, the moisture content either increases or decreases, causing fluctuations of swelling and shrinking. These fluctuations can cause splitting in the wood across the grain, as well as along the end portions. Therefore, in order to prepare wood for use or cutting, it must first go through a drying process to reduce the moisture content and thereby reduce the effects of shrinkage and swelling.

The drying process can either be executed through use of a kiln or induced naturally by air-drying the wood. Wood dries from the outside in, meaning that the shell or outer surface of a log will have significantly lower moisture content than the core or inner body of the log. Once the shell reaches a lower moisture content and is “set,” resistance to shrinkage is much greater. The core then continues to dry and shrink further, causing pressure on the “set” shell. Exposed faces of the shell may begin to crack as the core of the log compresses further.

Cracked segments reduce the portion of timber usable for creating products such as lumber and veneer as the ends are often discarded, due to the inconsistency of timber in the regions of logs where cracking is most severe. Although, higher grade logs have an absence of knots, the absence of knots allows cracks to develop more quickly by following straight grain patterns for the length of the timber.

A variety of methods and techniques directed to preventing cracks and splits in logs have been developed. Some methods used to prevent cracks include, waxing the exposed ends, inserting metal “S” irons to prevent further cracking, or inserting other anti-splitting devices. Logsavers® and Flitchsavers®, sold by the U•C Coatings Corporation of Buffalo N.Y., are an effective alternative to “S” irons as they are made from plastic so they can be left in the log during processing, and also can be attached to a hammer to allow for easy insertion with a single swing. In order to minimize or prevent the branching of multiple cracks or splits, truss plates are often driven into the end face of logs. Another example of an anti-splitting device includes a spiked plate described in U.S. Pat. No. 7,721,400 (hereinafter “the '400 Patent”) which includes projections to grip wood along either side of a crack.

While the above described methods may offer some benefits, each method is limited in certain aspects. For example, wax often does not limit further expansion of existing splits and mainly provides checking of the drying process, i.e., slows the rapid reduction of moisture in wood that results in splitting. Metal “S” irons as well as truss plates often create staining in the wood and also require removal before wood can be processed, while other methods such as plastic clips are limited in their strength and ability to prevent newly occurring splits. “S” irons and truss plates are also difficult to be inserted as they must be stabilized with one hand as they are driven into the face of the timber with a hammer. Removal of “S” irons or truss plates is also very time consuming in that there are few specific tools for removal, and the ones that do exist are often difficult to use and ineffective. Some anti-splitting devices, e.g., the spiked plate described in the '400 Patent, require a specially designed tool for removal, which fails to address or eliminate the spiked plate's drawbacks because the need for removal of the plates and the difficulty associated therewith have not been eliminated. All of the foregoing anti-splitting devices that require insertion into the face of logs further present the possibility of creating additional points of stress where new cracks may develop as each device includes cleats or analogous structures which come to sharp abrupt endpoints. The sharp endpoints act as wedges and therefore aid in potential further cracking.

Metal “S” irons inserted into faces of timber have long been used to prevent cracks therein. Irons are hammered into the face of a log, traversing splits that have already formed and act to contain the split from further expansion. Unfortunately, these irons are not the most effective method for a variety of reasons. In order to insert an “S” iron into the face of a log, it must be held in place by the hand of a logger, while another hand swings a hammer at the “S” iron thereby driving it into place within the log. This clearly poses a dangerous safety concern for a user. Additionally, once inserted in the timber, the metal of the “S” iron may stain the wood, making it less desirable or sellable. This device also creates an extra step in processing timber as the “S” irons must be removed from the wood before the timber can be manufactured or processed into a usable product.

Another known method used to prevent splitting is through the application of truss plates to the faces of logs. Metal truss plates include “teeth” designed to help transport loads of wood. The truss plates are inserted by driving the plates into the faces of logs, in a similar manner to “S” irons. Truss plates aid in preventing the branching of multiple cracks. This method also poses the problems of wood staining and the need to remove the plate prior to manufacture. Because of the necessity for removal, not only is another step added to the process, but removal is time consuming and difficult due to the lack of suitable tools. Few tools are available to carry out the removal process concerning both “S” irons and truss plates, and those tools that are available are difficult to use and largely ineffective.

Therefore, there has been a long felt need in the logging industry for an anti-splitting device, which effectively prevents cracks from spreading without damaging the wood, while also eliminating or minimizing the challenging removal process.

### SUMMARY OF THE INVENTION

Generally, the present disclosure describes a device used to alleviate splits as or before they occur in logs or log derivatives during the drying process. In an embodiment, the device has integral geometric protrusions, e.g., tapered circular protrusions, projecting from the surface of the plate, strip, or other device. After placement into a log or log derivative by pressure or impact, the present device straddles the split while maintaining retention in the log or log derivative to restrict further growth or widening of a split.

According to aspects illustrated herein, an embodiment of a present anti-splitting device includes a base portion, a plurality of protrusions and first, second, third and fourth extensions. The base portion has a first surface and a second surface oppositely disposed relative to the first surface, a first edge and a second edge oppositely disposed relative to the first edge, and a third edge and a fourth edge oppositely disposed relative to the third edge. The plurality of protrusions are positioned about and extending from the first surface. The first extension is positioned at an intersection of the first and third edges, the second extension is positioned at an intersection of the third and second edges, the third extension is positioned at an intersection of the second and fourth edges and the fourth extension is positioned at an intersection of the fourth and first edges. Each of the first, second, third and fourth extensions extend from the second surface.

According to aspects illustrated herein, an embodiment of a present anti-splitting device includes a base portion, a plurality of protrusions and first, second, third and fourth extensions. The base portion has a first surface and a second surface oppositely disposed relative to the first surface, a first edge and a second edge oppositely disposed relative to the first edge, and a third edge and a fourth edge oppositely disposed relative to the third edge. The plurality of protrusions are positioned about and extending from the first surface. The first extension is positioned at an intersection of the first and third edges, the second extension is positioned at an intersection of the third and second edges, the third extension is positioned at an intersection of the second and fourth edges and the fourth extension is positioned at an intersection of the fourth and first edges. Each of the first and fourth extensions extends from the second surface along the first edge and each of the second and third extensions extends from the second surface along the second edge.

According to aspects illustrated herein, the present disclosure sets forth an embodiment of a method of making an anti-splitting device from a base plate having a first surface and a second surface oppositely disposed relative to the first surface, a first edge and a second edge oppositely disposed relative to the first edge, and a third edge and a fourth edge oppositely disposed relative to the third edge. The method includes: a) forming a plurality of teeth and first, second, third and fourth extensions in the base plate; b) bending the plurality of teeth in a direction extending from and substantially perpendicular to the first surface; and, c) bending the first, second, third and fourth extensions in a direction extending from and substantially perpendicular to the second surface.

According to aspects illustrated herein, an embodiment of the present anti-splitting device includes a back plate that creates a platform to connect geometric protrusions. The protrusions can be formed in a variety of ways, including but not limited to, teeth, cylindrical cleats, frusto-conical cleats, curved blades, splittable protrusions, etc. and are preferably integrally formed with the back plate. In an embodiment having frusto-conical cleat protrusions, the cleats are tapered such that the leading end of each cleat, i.e., the portion of the cleat that first impacts the face of the material where cracks develop, are narrower than the base of each cleat, i.e., the portion of the cleat connected to the back plate, thereby enabling an easier insertion into the log or log derivative material. In some embodiments, each cleat includes a partial through-bore running from the leading end to the base to enable even distribution patterns of the fibers within the work material, e.g., timber fibers. This minimizes additional stresses created by the insertion of the anti-splitting device. Further, the hollow cleat design creates additional surface area that contacts the work material, which enables increased retention of the anti-splitting device. This increased retention will allow for increased strength as the device will remain in the desired position as forces at the crack increase.

As described above, the typical anti-splitting devices wedges that are used to prevent further expansion of the crack can create focal points of stress in the work material, which can in turn create precise points of stress. These points of stress run the risk of creating additional cracks or splits. The widened back plate of some embodiments of the present device that connects the cleats enables a robust design providing strength and rigidity to the plate, thus allowing for increased crack prevention over a larger surface area.

In some embodiments, the present anti-splitting device includes a plastic plate with protruding tapered cleats that penetrate the wood to prevent current and further cracks or splits. This plate can be attached to a hammer or other driving device and subsequently driven into the face of timber or other products that are at risk of checking, thereby preventing the development of splits.

It would be advantageous to provide an anti-splitting device with cylindrical cleats to prevent the expansion of current cracks or splits as well as preventing development of new cracks. The advantage of circular cleats is in the equal displacement of material around the outside and inside diameters of the cleat, creating a stress relieved wedge that provides ease of insertion, while creating a grip on the wood fibers in such a fashion to promote retention and prevents the further development of splits.

In some embodiments, the device is made of plastic so that the device does not require removal during processing. In some embodiments, the device is made of steel. In some embodiments, the device is made of galvanized steel to prevent staining of the wood.

It is a general object of the present invention to provide a device that can be inserted with either a simple hammer, a custom designed hammer, an impact hammer, or other compression devices.

These and other objects, advantages and features of the presently described embodiments will be better appreciated by those having ordinary skill in the art in view of the following detailed description of the invention in view of the drawings.

### BRIEF DESCRIPTION OF THE DRAWINGS

For a better understanding of embodiments of the invention and to show how the same may be carried into effect, reference will now be made, purely by way of example, to the accompanying drawings in which like reference characters designate corresponding elements or sections throughout.

In the accompanying drawings:

FIG. 1 is a perspective view of an embodiment of the present invention;

FIG. 2 is a perspective view of the embodiment shown in FIG. 1 operatively secured to a hammer;

FIG. 3 is a top plan view of a die-cut pattern of the embodiment shown in FIG. 1;

FIG. 4 is a top plan view of the embodiment shown in FIG. 1;

FIG. 5 is a side elevational view of the embodiment shown in FIG. 1;

FIG. 6 is a front elevational view of the embodiment shown in FIG. 1;

FIG. 7 is a perspective view of another embodiment of the present invention;

FIG. 8 is a perspective view of another embodiment of the present invention;

FIG. 9 is a perspective view of an embodiment of the present invention after having been removed from a work piece;

FIG. 10 is a perspective view of another embodiment of the present invention; and,

FIG. 11 is a front elevational view of the embodiment shown in FIG. 10.

### DETAILED DESCRIPTION OF THE INVENTION

At the outset, it should be appreciated that like reference characters are used for like elements of the present embodiments or elements of like function. For the sake of clarity, only those elements and reference characters which are of relevance to the shown aspects of the respective embodiment of the present invention are shown repeatedly. In this regard, no attempt is made to show structural details of the invention in more detail than is necessary for a fundamental understanding of the invention, the description taken with the drawings making apparent to those skilled in the art how the several forms of the invention may be embodied in practice.

While the present invention is described with respect to what is presently considered to be the preferred aspects, it is to be understood that the invention as claimed is not limited to the disclosed aspects. The present invention is intended to include various modifications and equivalent arrangements within the spirit and scope of the appended claims.

Furthermore, it is understood that this invention is not limited to the particular methodologies, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

In the below description, an embodiment is an example or implementation of the invention. The various appearances of “one embodiment”, “an embodiment”, “a preferred embodiment, “certain embodiments” or “some embodiments” do not necessarily all refer to the same embodiments.

“Frusto-conical”, as used herein is intended to mean having the shape of a frustum of a cone, while “frustrum” is intended to mean the part of a shape left after cutting off a top portion of the shape with a plane parallel to the base of the shape. “Substantially perpendicular”, as used herein, is intended to mean about ninety degrees relative to a surface, e.g., between eighty and one hundred degrees.

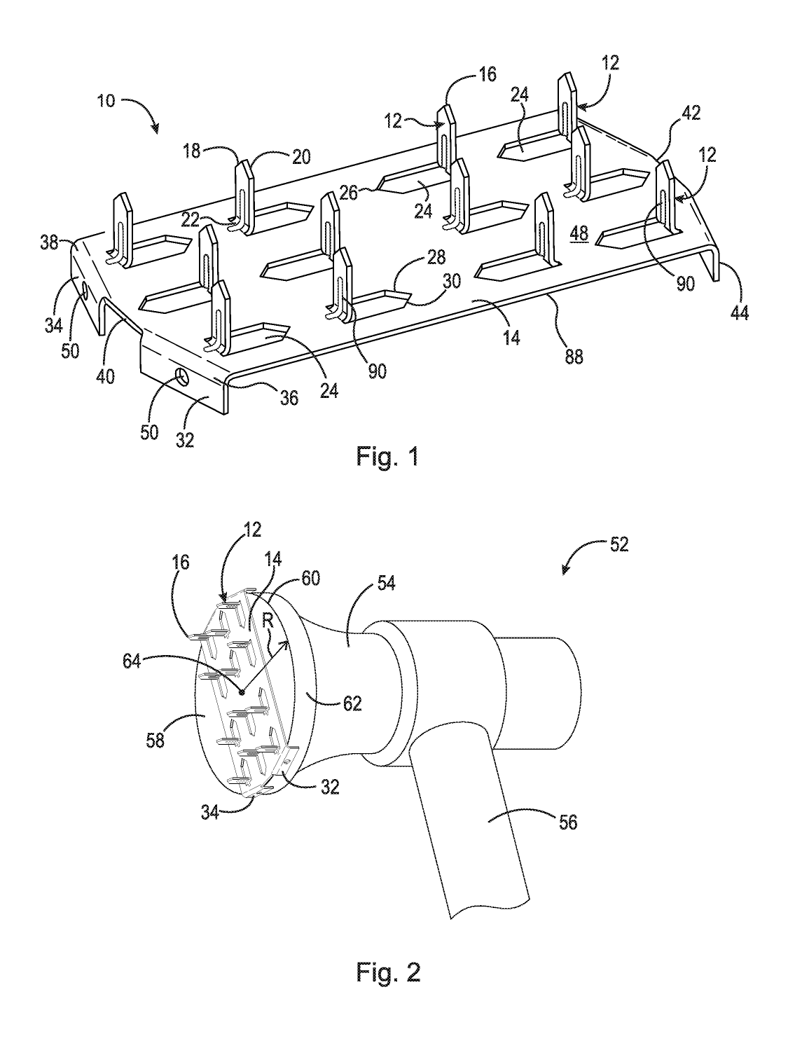

Adverting now to the drawings, FIG. 1 is a perspective view of an embodiment of the present anti-splitting device, i.e., anti-splitting device 10. Device 10 has a plurality of teeth 12 protruding in an upward direction from plate 14. Teeth 12 each have tip 16 created by beveled surfaces 18 and 20, and are bent upward along fold line 22. Plate 14 also has a plurality of gaps 24 each with a complementary shape to teeth 12. Gaps 24 each have tip 26 formed by beveled surfaces 28 and 30.

Further, device 10 has tabs 32 and 34 protruding in a downward direction, i.e., in a direction opposite teeth 12, from plate 14. Tab 32 is bent downward along fold line 36, and tab 34 is bent downward along fold line 38. Tabs 32 and 34 are separated by end surface 40. Plate 14 also has end surface 42, which separates a second pair of tabs, i.e., tabs 44 and 46.

In the embodiment shown in FIG. 1, top surface 48 of plate 14 is flat with only teeth 12 and tabs 32, 34, 44 and 46 disrupting the evenness of surface 48. However, as described above, tabs 32, 34, 44 and 46 may also be described as extending from the bottom surface opposite top surface 48. Further, the embodiment shown is an integral piece of material that is only perforated at gaps 24 and bores 50. Bores 50 are present to facilitate in the removal of device 10 from a work piece in which it has been inserted. In other terms, tabs 32, 34, 44 and 46 remain extending from the end of the in which device 10 is inserted. Tabs 32, 34, 44 and 46 provide a convenient location to grip device 10 for removal. Bores 50 provide additional gripping locations for purposes of removal. It should be appreciated that common tools may be used for such removal, e.g., end cutter pliers. Moreover, tabs 32, 34, 44 and 46 also provide a convenient and repeatable means of securing device 10 on a driving means as described below. Tabs 32, 34, 44 and 46 are substantially linear so that device 10 can be secured to a variety of driving means without the need for grooves, holes, etc. on or in the driving means. It should be appreciated that as used herein, “substantially linear” is intended to mean a generally flat surface devoid of bends, crimps, protrusions, etc. extending therefrom or formed therein.

FIG. 2 is a perspective view of device 10 operatively secured to hammer 52. In general, hammer 52 has head 54 fixedly secured to shaft 56. Device 10 is secured to driving end 58 of hammer head 54 by a snap-fit or interference fit. Driving end 58 is circular with radius R. Fold lines 36 and 38 of tabs 32 and 34, respectively, and fold lines 66 and 68 of tabs 44 and 46, respectively, are configured to correspond with rim 60 such that tabs 32, 34, 44 and 46 extend along and engage with circumferential surface 62 of hammer head 54 without the need to interact with grooves, holes, etc. Preferably, midpoint 64 of device 10 corresponds to the center of driving end 58 having radius R. In an embodiment, device 10 is magnetically secured to driving end 58 of hammer head 54, for example, by use of magnetic elements embedded within driving end 58.

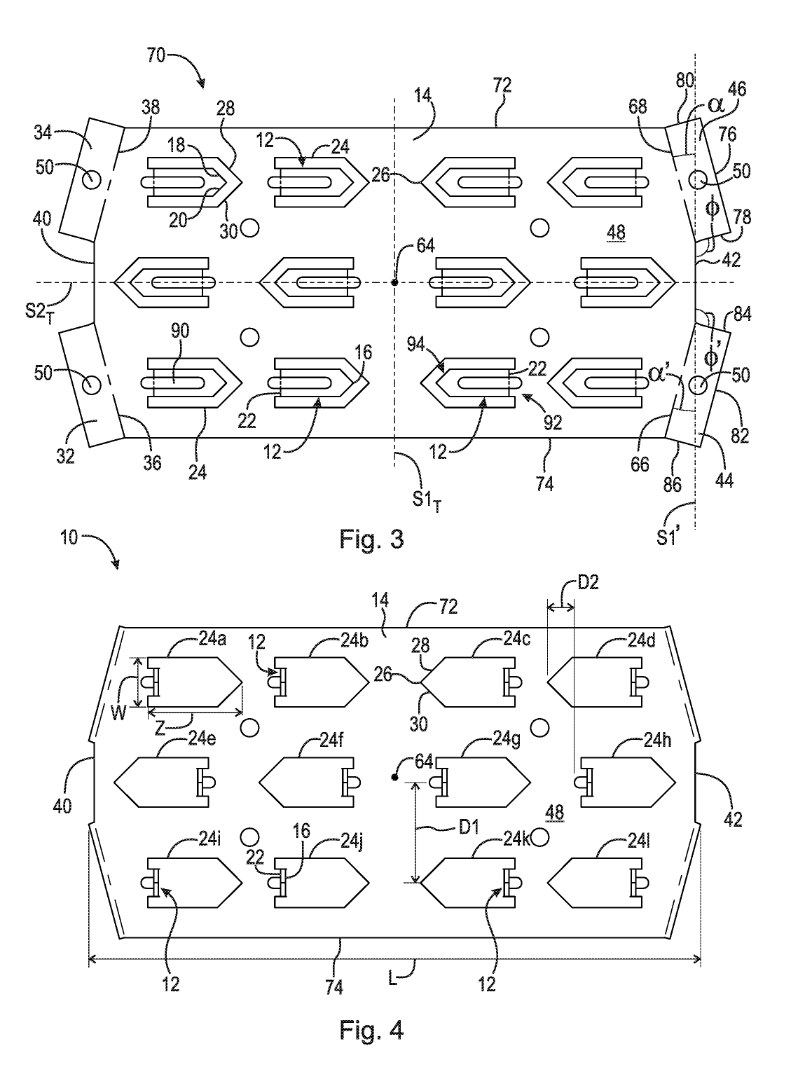

FIG. 3 is a top plan view of die-cut pattern 70 for use in forming device 10, i.e., before teeth 12 and tabs 32, 34, 44 and 46 are folded along their respective folding lines. The die-cut pattern has two lines of symmetry running through midpoint 64: S1_{T} running from edge 72 to edge 74 separating end 40 from end 42; and, S2_{T} running from end 40 to end 42 separating edge 72 from edge 74. It should be appreciated that a variety of methods may be used to form pattern 70, e.g., die cutting, stamping, laser cutting, water jet cutting, etc., and such variations fall within the spirit and scope of the claims below.

Preferably, the die-cut pattern has ends 40 and 42 parallel to S1_{T}, e.g., end 42 creates line S1′ parallel to S1_{T}, and fold lines 36 and 38 of tabs 32 and 34, respectively, and fold lines 66 and 68 of tabs 44 and 46, respectively, are configured at angles relative to S1_{T}. For example, fold line 68 of tab 46 is at angle α with respect to S1′, and fold line 66 is at angle α′ with respect to S1′. Due to device 10 being symmetric along line S2_{T}, in some embodiments, angle α′ is the mirrored angle of α.

Tab 46 has edge 76 configured parallel to fold line 68, inner edge 78 configured at angle φ with respect to S1′, and outer edge 80 parallel to inner edge 78, i.e., at angle φ with respect to S1′ because of the alternate exterior angles theorem.

Tab 44 has edge 82 configured parallel to fold line 66, inner edge 84 configured at angle φ′ with respect to S1′, and outer edge 86 parallel to inner edge 84, i.e., at angle φ′ with respect to S1′. Due to line of symmetry S2_{T}, tab 44 is at a mirrored configuration with respect to tab 46, meaning that φ=φ′. It should be appreciated that the angular relationships between tabs 32 and 34 and end 40 is substantially similar to the foregoing arrangement of tabs 44 and 46 relative to end 42.

FIG. 4 is a top view of device 10 with teeth 12 and tabs 32, 34, 44 and 46 bent along their respective fold lines. Device 10 has length L between end 40 and end 42. Teeth 12 are depicted coming out of the paper upwardly and can be configured in a variety of patterns. In some embodiments, teeth 12 and their gaps 24 are configured in three rows parallel to side edges 72 and 74, and four columns running from end surface/edge 40 to end surface/edge 42. For example, device 10 may include a first row comprising gaps 24a, 24b, 24c, and 24d; a second row comprising gaps 24e, 24f, 24g, and 24h; and, a third row comprising gaps 24i, 24j, 24k, and 24l. Thus, a first column comprises gaps 24a, 24e, and 24i; a second column comprises gaps 24b, 24f, and 24j; a third column comprises gaps 24c, 24g, and 24k; and, a fourth column comprises gaps 24d, 24h, and 24l. In some embodiments, each gap 24a-24l has the same dimensions with width W running perpendicular to side edges 72 and 74, and length Z running parallel to side edges 72 and 74.

In some embodiments, the rows are evenly spaced apart with the first and third rows equidistant from the middle second row by distance D1. In the embodiment depicted in FIG. 4, distance D1 is the distance between tips 26 of gaps 24g (in the second row) and 24k (in the third row). The first row is proximate side edge 72, the third row is proximate side edge 74, and the second row is situated therebetween.

With respect to the columns, the first column (gaps 24a, 24e, and 24i) is proximate end 40, and the fourth column (gaps 24d, 24h, and 24l) is proximate end 42. The second column (gaps 24b, 24f, and 24j) is situated between the first column and midpoint 64, and the third column (gaps 24c, 24g, and 24k) is situated between midpoint 64 and the fourth column. The gaps, and therefore their respective teeth, in the first and third rows of the first and second columns have their respective bases/fold lines 22 proximate end 40 and their respective tips distal to end 40, while the second row of the first and second columns have their respective bases/fold lines 22 proximate end 42 and their respective tips distal to end 42. Similarly, the gaps in the first and third rows of the third and fourth columns have their respective bases/fold lines 22 proximate end 42 and their respective tips distal to end 42, while the second row of the third and fourth columns have their respective bases/fold lines 22 proximate end 40 and their respective tips distal to end 40. As can be seen in FIG. 4, the gaps in the first and second rows in the first and second columns point with their tips toward end 42, and the gaps in the first and second rows in the third and fourth columns point with their tips toward end 40. Thus, once teeth 12 are bent along their respective fold lines 22, teeth 12 protrude from top surface 48 at a higher density near ends 40 and 42 as opposed to near the center of device 10, as will be discussed in more detail with reference to FIG. 6 below. Moreover, teeth 12 located in the second row are rotated one hundred eighty degrees (180°) relative to teeth 12 located in the first and third rows, thereby providing additional space for a user of device 10 to grip the device while placing the same on a driving tool such as hammer 52 as depicted in FIG. 2. In view of the sharp nature of tips 16 of teeth 12, the additional space assists with minimizing injuries while using device 10.

In some embodiments, the outer columns, i.e., the first and fourth columns, have their outer gaps, i.e., gaps 24e and 24h, respectively, off-set from the other gaps within that column. As shown in the embodiment depicted in FIG. 4, gap 24h is off-set distance D2. It should be appreciated that the present anti-splitting device may include greater than or less than three rows and/or four columns of teeth 12, and such variations are within the spirit and scope of the claims below.

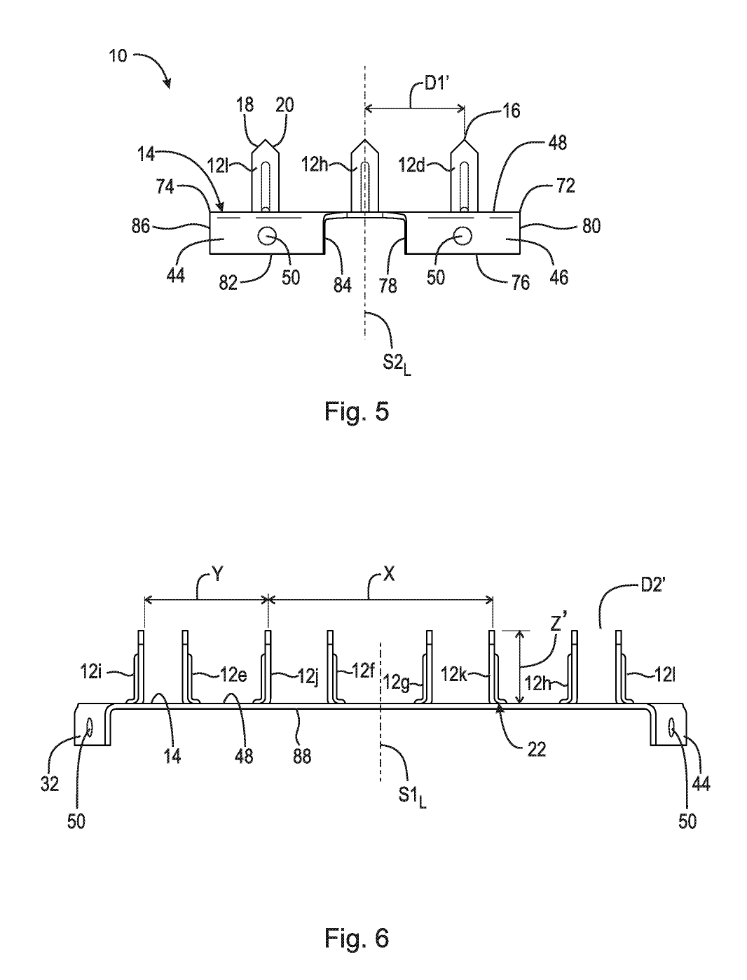

FIG. 5 is a side elevational view of device 10 showing line of symmetry S2_{L} that separates side edge 72 from side edge 74. In some embodiments, line S2_{L} runs through tooth 12h, which tooth corresponds to gap 24h. Teeth 12a-12l correspond to gaps 24a-24l. Tips 16 of teeth 12d and 12h are separated by distance D1′, which is equivalent to distance D1 between tips 26 of gaps 24 shown in FIG. 4. FIG. 5 shows the rows of the gaps and respective teeth are evenly spaced apart with the first and third rows equidistant from the middle second row by distance D1′.

FIG. 6 is a front elevational view of the present device with line of symmetry S1_{L} separating ends 40 and 42. Teeth 12i, 12e, 12j, 12f, 12g, 12k, 12h, and 12l all correspond to their respective gap, i.e., gaps 24i, 24e, 24j, 24f, 24g, 24k, 24h and 24l. As described above with respect to FIG. 4, gaps 24 point toward either end 40 or 42 of the device. As a result of this configuration, once teeth 12 are bent along their respective fold lines 22, teeth 12 protrude from top surface 48 at a higher density near ends 40 and 42 as opposed to center 64 of device 10. As such, distance X shown in FIG. 6 between the tips of teeth 12j and 12k of the second and third columns, respectively, is greater than distance Y between the tips of teeth 12j and 12i, of the first and second columns. Further, distance Y is greater than distance D2′ between teeth 12l and 12h, both teeth of the fourth column, such that X>Y>D2′. With the density of teeth increasing towards ends 40 and 42 of device 10, the device can be inserted into a piece of wood around a pre-existing split without having any protrusions exacerbate the split further.

The following is best understood in view of FIGS. 1-6. In some embodiments, the present anti-splitting device, e.g., anti-splitting device 10 comprises base portion 14, a plurality of protrusions 12 and first, second, third and fourth extensions 34, 46, 44 and 32, respectively. Base portion 14 comprises first surface 48 and second surface 88 oppositely disposed relative to first surface 48. Base portion 14 further comprises first edge 40 and second edge 42 oppositely disposed relative to first edge 40, and third edge 72 and fourth edge 74 oppositely disposed relative to third edge 72. The plurality of protrusions 12 are positioned about and extending from first surface 48. First extension 34 is positioned at an intersection of first and third edges 40 and 72, respectively, second extension 46 is positioned at an intersection of third and second edges 72 and 42, respectively, third extension 44 is positioned at an intersection of second and fourth edges 42 and 74, respectively, and fourth extension 32 is positioned at an intersection of fourth and first edges 74 and 40, respectively. Each of first, second, third and fourth extensions 34, 46, 44 and 32, respectively, extend from second surface 88.

In some embodiments, each of the plurality of protrusions/teeth 12 comprises strengthening rib 90. In some embodiments, at least one of first, second, third and fourth extensions 34, 46, 44 and 32, respectively, comprises through hole/bore 50. In some embodiments, base portion 14, plurality of protrusions 12 and first, second, third and fourth extensions 34, 46, 44 and 32, respectively, are formed from a continuous material. In some embodiments, the continuous material is steel, galvanized steel or plastic. In some embodiments, the continuous material is plastic and the plastic is a thermoplastic or a thermoset resin.

In some embodiments, the plurality of protrusions/teeth 12 are arranged in at least three rows extending between first and second edges 40 and 42, respectively. In some embodiments, base portion 14 comprises midpoint 64 and the plurality of protrusions 12 are arranged in first, second and third rows, where the second row is arranged between the first and third rows. Each of the plurality of protrusions 12 in the second row comprises fold line 22, first end 92 and second end 94 opposite first end 92 and distal to midpoint 64, with fold line 22 is arranged at first end 92. In some embodiments, base portion 14 comprises midpoint 64 and the plurality of protrusions 12 are arranged in first, second and third rows, where the second row is arranged between the first and third rows. Each of protrusions 12 in the second row comprises fold line 22, first end 92 and second end 94 opposite first end 92 and distal to midpoint 64, with fold line 22 is arranged at first end 92, and each of the plurality of protrusions 12 in the first and third rows comprises fold line 22, first end 92 and second end 94 opposite first end 92 and distal to midpoint 64, with fold line 22 arranged at second end 94.

Alternatively, in some embodiments, the present anti-splitting device, e.g., anti-splitting device 10 comprises base portion 14, a plurality of protrusions/teeth 12 and first, second, third and fourth extensions 34, 46, 44 and 32, respectively. Base portion 14 comprises first surface 48 and second surface 88 oppositely disposed relative to first surface 48. Base portion 14 further comprises first edge 40 and second edge 42 oppositely disposed relative to first edge 40, and third edge 72 and fourth edge 74 oppositely disposed relative to third edge 72. The plurality of protrusions 12 are positioned about and extending from first surface 48. First extension 34 is positioned at an intersection of first and third edges 40 and 72, respectively, second extension 46 is positioned at an intersection of third and second edges 72 and 42, respectively, third extension 44 is positioned at an intersection of second and fourth edges 42 and 74, respectively, and fourth extension 32 is positioned at an intersection of fourth and first edges 74 and 40, respectively. Each of first and fourth extensions 34 and 32, respectively, extends from second surface 88 along first edge 40 and each of second and third extensions 46 and 44, respectively, extends from second surface 88 along second edge 42.

Moreover, it should be appreciated that the present disclosure also sets forth a method of making an anti-splitting device, e.g., device 10. Device 10 is formed from base plate 14 comprising first surface 48 and second surface 88 oppositely disposed relative to first surface 48, first edge 40 and second edge 42 oppositely disposed relative to first edge 40, and third edge 72 and fourth edge 74 oppositely disposed relative to third edge 72. An embodiment of the present method comprises the following steps. First, a plurality of teeth 12 and first, second, third and fourth extensions 34, 46, 44 and 32, respectively, are formed in base plate 14. Examples of techniques for forming teeth 12 and tabs 32, 34, 44 and 46 within pattern 70 are discussed above, e.g., die cutting. Next, the plurality of teeth 12 are bent in a direction extending from and substantially perpendicular to first surface 48. Then, first, second, third and fourth extensions 34, 46, 44 and 32, respectively, are bent in a direction extending from and substantially perpendicular to second surface 88.

In some embodiments, the present method further comprises forming strengthening rib 90 in each of the plurality of teeth 12. In some embodiments, the step of forming strengthening rib 90 in each of the plurality of teeth 12 is performed before, during or after the step of forming a plurality of teeth 12 and first, second, third and fourth extensions 34, 46, 44 and 32, respectively, in base plate 14. In some embodiments, the present method further comprises forming through hole 50 in at least one of the first, second, third and fourth extensions 34, 46, 44 and 32, respectively. In some embodiments, the step of forming through hole 50 in at least one of the first, second, third and fourth extensions 34, 46, 44 and 32, respectively, is performed before, during or after the step of forming a plurality of teeth 12 and first, second, third and fourth extensions 34, 46, 44 and 32, respectively, in base plate 14.

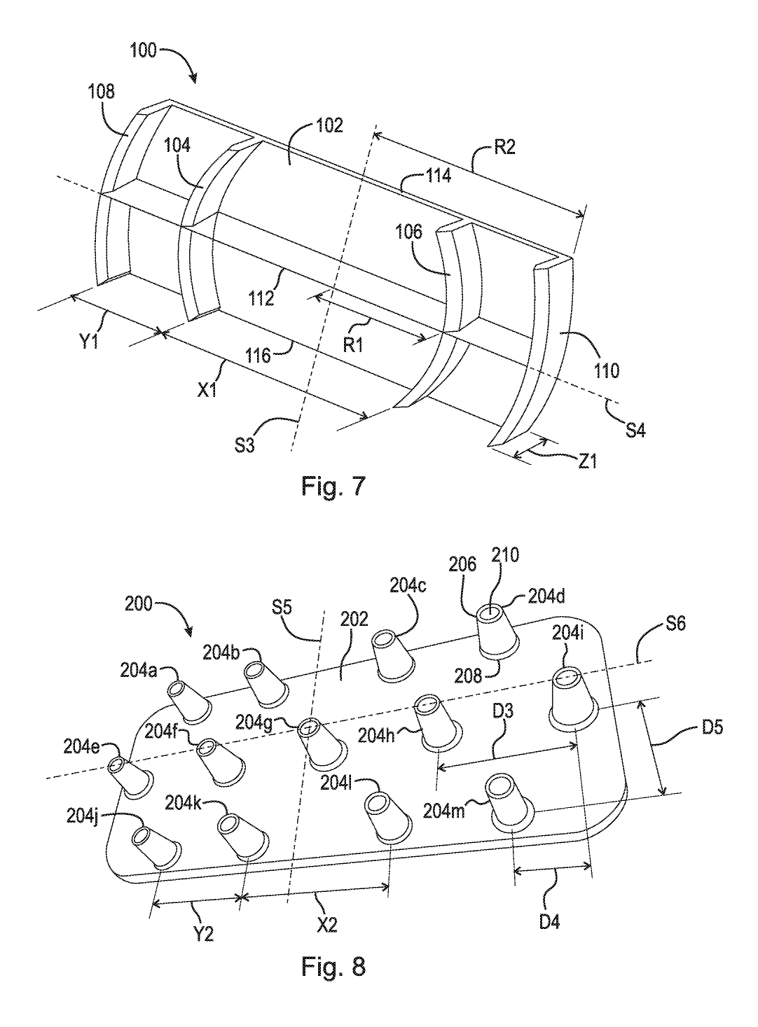

FIG. 7 is a perspective view of device 100 according to an example embodiment of the present invention. Device 100 comprises back plate 102 with curved protrusions 104, 106, 108, and 110 extending in an upward direction. Protrusions 104 and 106 are curves having radius R1, are configured with their concave surfaces facing each other and are both concentric to protrusions 108 and 110. Protrusions 108 and 110 are curves having radius R2 and are also configured with their concave surfaces facing each other. Central blade 112 extends longitudinally from outer curve 108 to outer curve 110. In some embodiments, R1<R2 or R1>R2. Device 100 has line of symmetry S3 separating curves 104 and 108 from curves 106 and 110, and, line of symmetry S4 separating lateral edge 114 from lateral edge 116.

FIG. 8 is a perspective view of device 200 according to an example embodiment of the present invention having lines of symmetry S5 and S6. Device 200 has back plate 202 with a plurality of protrusions, or cleats, 204a-204m. Each protrusion 204 has circular leading end 206 and circular base 208. In some embodiments, protrusions 204a-204m are frusto-conical with leading end 206 being narrower than base 208. In some embodiments, protrusions 204a-204m are cylindrical with leading end 206 having the same radius as base 208. In some embodiments, protrusions 204a-204m are mixed frusto-conical and cylindrical protrusions. Preferably, cleats 204a-204m are hollow having partial through-bore 210 running from leading end 206 to base 208. In some embodiments, bore 210 is a full through-bore and perforates back plate 202 creating a channel connecting the rear surface of the back plate with the leading end of the cleat.

In some embodiments, device 200 has protrusions 204 configured in three rows and five columns. For example, a first row comprises protrusions 204a-204d, a second row comprises protrusions 204e-204i, and a third row comprises protrusions 204j-204m. The protrusions in the second row are evenly spaced by a distance D3, whereas the first and third rows have unevenly spaced protrusions with distance X2 between the middle protrusions, e.g., between 204k and 204l, being larger than distance Y2 between protrusions 204j and 204k. The rows of device 200 are evenly spaced apart with the first and third rows equidistant from the middle second row by distance D5.

Furthermore, in some embodiments, device 200 has five columns: a first column comprises protrusions 204a, 204e, and 204j; a second column comprises protrusions 204b, 204f, and 204k; a third column comprises central protrusion 204g; a fourth column comprises protrusions 204c, 204h, and 204l; and, a fifth column comprises protrusions 204d, 204i, and 204m. The outer columns, i.e., the first and fifth columns, have their middle protrusions, i.e., protrusion 204e and 204i, respectively, off-set by a distance D4 from the other gaps within that column. In some embodiments, protrusions 204 are in a pattern such that the protrusions are at the vertices of two hexagons having a shared vertex, and a protrusion at the center of each hexagon.

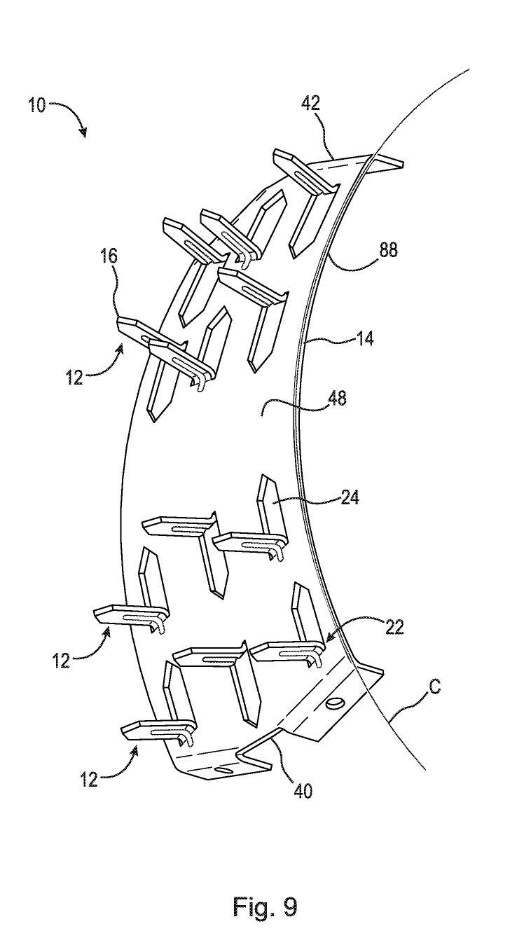

FIG. 9 is a perspective view of a used device 10 that has been removed from the work piece into which it had previously been inserted. Used device 10 shown in FIG. 9 has all of teeth 12 intact with none having been torn off and left behind in the work piece after removal.

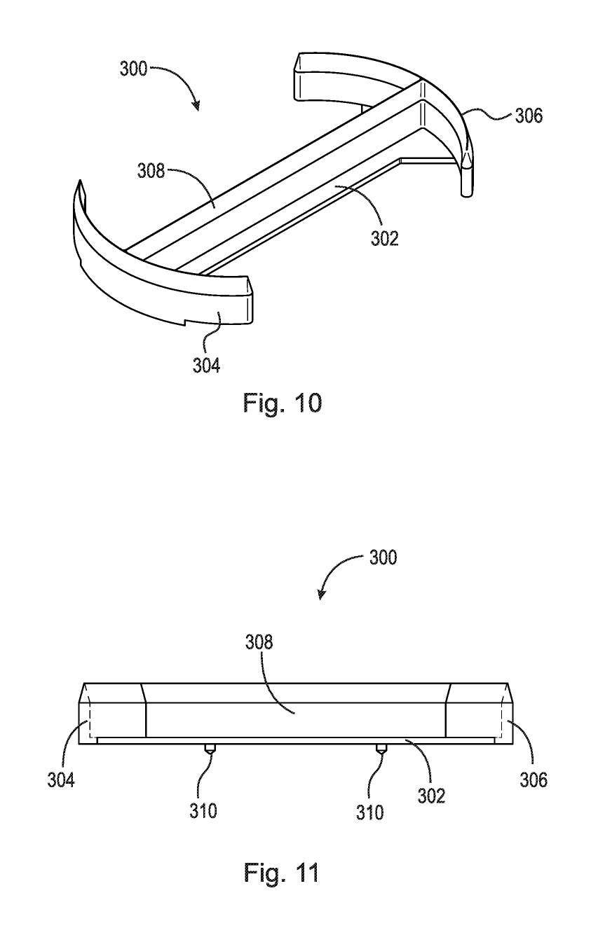

FIG. 10 is a perspective view of another embodiment of a present anti-splitting device, i.e., device 300. Device 300 includes back plate 302, oppositely disposed arcuate protrusions 304 and 306, central linear protrusion 308, and engagement protrusions 310. It has been found that anti-splitting device 300 performs more consistently than prior known anti-splitting devices due to the introduction of back plate 302. It is believed that back plate 302 increases the strength of the overall article as back plate 302 increases the strength of the connection between arcuate protrusions 304 and 306 and linear protrusion 308. In short, the arrangement of the connection is stronger than simply bonding arcuate protrusions 304 and 306 to the terminal ends of linear protrusion 308. Additionally, it is believed that the increased surface area provided by back plate 302 improves the transfer of force from a driving device, e.g., a hammer, to device 300, thereby increasing consistency of placement of device 300 within a work piece. In some embodiments, each of protrusions 304, 306 and 308 include a wedged shape at these respective ends distal from back plate 302. Engagement protrusions 310 are provided to temporarily secure device 300 to a driving device, e.g., a hammer, for subsequent insertion into a work piece, e.g., an end of a log.

Thus, it is seen that the objects of the present invention are efficiently obtained, although modifications and changes to the invention should be readily apparent to those having ordinary skill in the art, such modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention as claimed.

What is claimed is:

1. An anti-splitting device comprising:
a base portion comprising a first surface and a second surface oppositely disposed relative to the first surface, a first edge and a second edge oppositely disposed relative to the first edge, and a third edge and a fourth edge oppositely disposed relative to the third edge;
a plurality of protrusions positioned about and extending from the first surface; and,
a first extension positioned at an intersection of the first and third edges, a second extension positioned at an intersection of the third and second edges, a third extension positioned at an intersection of the second and fourth edges and a fourth extension positioned at an intersection of the fourth and first edges,
wherein each of the first, second, third and fourth extensions extend from the second surface.

2. The anti-splitting device of claim 1 wherein each of the plurality of protrusions comprises a strengthening rib.

3. The anti-splitting device of claim 1 wherein at least one of the first, second, third and fourth extensions comprises a through hole.

4. The anti-splitting device of claim 1 wherein the base portion, the plurality of protrusions and the first, second, third and fourth extensions are formed from a continuous material.

5. The anti-splitting device of claim 4 wherein the continuous material is steel, galvanized steel or plastic.

6. The anti-splitting device of claim 5 wherein the continuous material is plastic and the plastic is a thermoplastic or a thermoset resin.

7. The anti-splitting device of claim 1 wherein the plurality of protrusions are arranged in at least three rows extending between the first and second edges.

8. The anti-splitting device of claim 1 wherein the base portion comprises a midpoint, the plurality of protrusions are arranged in first, second and third rows, the second row arranged between the first and third rows, and each of the protrusions in the second row comprises a fold line, a first end and a second end opposite the first end and distal to the midpoint, the fold line arranged at the first end.

9. The anti-splitting device of claim 1 wherein the base portion comprises a midpoint, the plurality of protrusions are arranged in first, second and third rows, the second row arranged between the first and third rows, each of the protrusions in the second row comprises a fold line, a first end and a second end opposite the first end and distal to the midpoint, the fold line arranged at the first end, and each of the protrusions in the first and third rows comprises a fold line, a first end and a second end opposite the first end and distal to the midpoint, the fold line arranged at the second end.

10. The anti-splitting device of claim 1 wherein at least one of the first, second, third or fourth extensions are substantially linear.

11. An anti-splitting device comprising:
a base portion comprising a first surface and a second surface oppositely disposed relative to the first surface, a first edge and a second edge oppositely disposed relative to the first edge, and a third edge and a fourth edge oppositely disposed relative to the third edge;
a plurality of protrusions positioned about and extending from the first surface; and,
a first extension positioned at an intersection of the first and third edges, a second extension positioned at an intersection of the third and second edges, a third extension positioned at an intersection of the second and fourth edges and a fourth extension positioned at an intersection of the fourth and first edges,
wherein each of the first and fourth extensions extends from the second surface along the first edge and each of the second and third extensions extends from the second surface along the second edge.

12. A method of making an anti-splitting device from a base plate comprising a first surface and a second surface oppositely disposed relative to the first surface, a first edge and a second edge oppositely disposed relative to the first edge, and a third edge and a fourth edge oppositely disposed relative to the third edge, the method comprising:
a) forming a plurality of teeth and first, second, third and fourth extensions in the base plate;
b) bending the plurality of teeth in a direction extending from and substantially perpendicular to the first surface; and,
c) bending the first, second, third and fourth extensions in a direction extending from and substantially perpendicular to the second surface.

13. The method of claim 12 further comprising:
a1) forming a strengthening rib in each of the plurality of teeth.

14. The method of claim 13 wherein the step of forming a strengthening rib in each of the plurality of teeth is performed before, during or after the step of forming a plurality of teeth and first, second, third and fourth extensions in the base plate.

15. The method of claim 12 further comprising:
a1) forming a through hole in at least one of the first, second, third and fourth extensions.

16. The method of claim 15 wherein the step of forming a through hole in at least one of the first, second, third and fourth extensions is performed before, during or after the step of forming a plurality of teeth and first, second, third and fourth extensions in the base plate.

17. The method of claim 12 wherein the anti-splitting device is formed from steel or galvanized steel.

18. The method of claim 12 wherein the plurality of teeth are arranged in at least rows extending between the first and second edges.

19. The method of claim 12 wherein the base plate comprises a midpoint, the plurality of teeth are arranged in first, second and third rows, the second row arranged between the first and third rows, and each of the teeth in the second row comprises a fold line, a first end and a second end opposite the first end and distal to the midpoint, the fold line arranged at the first end.

20. The method of claim 12 wherein the base plate comprises a midpoint, the plurality of teeth are arranged in first, second and third rows, the second row arranged between the first and third rows, each of the teeth in the second row comprises a fold line, a first end and a second end opposite the first end and distal to the midpoint, the fold line arranged at the first end, and each of the teeth in the first and third rows comprises a fold line, a first end and a second end opposite the first end and distal to the midpoint, the fold line arranged at the second end.
